(19) United States
(12) Patent Application Publication
(10) Pub. No.: US 2020/0064300 A1
(43) Pub. Date: Feb. 27, 2020

(54) DISPOSABLE ELECTROCHEMICAL SENSING STRIPS AND ASSOCIATED METHODS

(71) Applicant: DEVICARE, S.L., Cerdanyola del Valles - Barcelona (ES)

(72) Inventors: Julian ALONSO CHAMARRO, Barcelona (ES); Maria Mar PUYOL BOSCH, Castelldefels, Barcelona (ES); Antonio CALVO LOPEZ, Llinars del Valles, Barcelona (ES)

(73) Assignee: DEVICARE, S.L., Cerdanyola del Valles - Barcelona (ES)

(21) Appl. No.: 16/609,695

(22) PCT Filed: Apr. 30, 2018
(86) PCT No.: PCT/EP2018/061062

§ 371 Date: Oct. 30, 2019

(30) Foreign Application Priority Data
May 3, 2017 (EP) 17382247.9

(51) Int. Cl. G01N 27/333; G01N 27/401; G01N 27/30; G01N 27/327

(52) U.S. Cl. CPC G01N 27/3335; G01N 27/3272; G01N 27/307; G01N 27/401

(57) ABSTRACT

Electrochemical sensing device (S) for measuring the content of ions in biological fluid samples (D) comprising two membrane half cells, a salt bridge (3) connecting them, means for bringing a biological fluid sample (D) in contact with the measuring cell, wherein the first and second membranes (11, 21) of the half-cells are selective to the same ions, the first volume (13) and second volume (23) adjacent to the membranes are filled with known concentrations (C1, C2) of the ions to which the membranes (11, 21) are selective, these known concentrations being different such that a voltage can be measured between the first electrode (12) and the second electrode (22) that allows calibrating the sensing device (S) and then measuring the ion-content of the sample. The invention also refers to a method using such sensing devices. The sensing devices are useful especially in the area of so-called home monitoring.

### TECHNICAL FIELD

The present invention relates to an electrochemical sensing device and specifically to a potentiometric strip, for measuring the content of ions in fluid samples, that is subjected to an auto-calibration step just before its use, thus allowing very accurate measurements. In a particular embodiment, the electrochemical sensing device is a disposable strip. It is useful especially in the area of so-called point-of-care testing and home monitoring, but it can be also applied to water analysis, environmental monitoring, food analysis and safety, industrial process control, and chemical/biochemical research, among others. The invention also relates to a method for measuring the content of ions in biological fluid samples that makes use of the inventive sensing device. Finally, the invention also relates to the minimization of the interferences of complex molecules e.g. plasmatic proteins present in biological fluids that may limit the accuracy of the measurements of the invented sensing device.

### STATE OF THE ART

Sensing devices industry faces an important challenge of developing and validating new analytical methods trying to operate at the extreme edges of analysis to obtain meaningful real time and in-situ information from smaller or more complex samples, and of species present at lower concentrations. Besides, there is a current trend towards employing more user-friendly instrumentation in some research fields as the development of drugs, biotechnology, medicine and environmental monitoring, because their evolution depends on the obtained information from the chemical analysis. In this context, a significant part of analytical chemistry focus their research on trying to avoid the use of large laboratories (centralized and remote) and sophisticated and expensive instruments to conversely develop systems closer to user.

This clearly implies the simplification of the analytical procedure, reducing sample and reagents consumption and minimizing manual intervention.

Two different conceptual approaches appear to address such a challenge. On the one hand, the development of sensors, which can reduce the number of stages of the analytical procedure as they include a recognition element, which gives selectivity or even specificity to the signal and therefore, avoids the analyte separation from the interferences. Moreover, it integrates other elements as the transducer and amplification steps to obtain the final signal. On the other hand, the automation of the entire procedure by means of robotized discrete methods based on continuous flow systems gives connectivity to the different steps and robustness.

The integration of both approaches results in the so-called Total Analysis Systems (TAS). These systems guarantee optimized results but, since they are not portable, they have little spatial and temporal resolution.

This has encouraged scientists to focus on instrumentation miniaturization and the development of the so-called Micrototal Analysis Systems (μTAS) or Lab-on-a-chip. They are miniaturized systems designed to perform all the steps of the analytical procedure (sampling, sample transport, sample pre-treatment, separation, detection and data analysis) in order to automatically obtain chemical information. Miniaturization obviously offers some advantages as portability, autonomy, costs saving, greener chemistry, improvement of the process operation, access to new effects due to scaling down and the possibility of performing in-situ measurements or ‘point-of-care’ diagnostics.

However, this faces many difficulties until its commercial implementation. To begin with, regarding technological aspects, there are great difficulties to standardize designs and processes, to integrate in a single device each of the operations of the analytical process and its components and at the end, to accomplish with the real commercial and usability requirements. On the other hand, there are other more fundamental issues due to the relative importance of some physical phenomena to micro-scale level and also to the fact that reducing sizes and volumes translates conventional analytical techniques to the limit and reduces the practical operation of these microsystems in the real world.

The present description focus on the field of potentiometric sensors based on ion-selective electrodes (ISEs), which convert the activity of a specific ion dissolved in an aqueous solution into an electrical potential. They are constituted by permselective membranes separating two different phases and measure the potential difference generated across the membrane by the selected ions. A net charge is determined by comparing this potential to a reference electrode. The resulting voltage is theoretically dependent on the logarithm of the ionic activity, according to the Nernst equation. Ion-selective electrodes are used in analytical chemistry and in biochemical/biophysical areas, where measurements of ionic concentration in an aqueous solution is required.

Until the date no disposable potentiometric devices are commercially available. Marketed devices consist of an electrochemical cell structure, which includes two different electrodes: one (or several) acts as a selective electrode(s) and another as a reference electrode. Usually the working electrode is the one that is disposable and for calibration, a conventional reference electrode is used, which is not for single use. These devices have important limitations such as the need of pre-calibration, interferences of other ions, and large sample consumption.

Not in the market but described in the art, there are some attempts of disposable miniaturized electrochemical devices. However, the main challenge of all of them is to achieve a good calibration just before the single use of the device, in a fully automatized way to be used by non-experienced staff.

As shown in FIG. 1, electrochemical sensing devices S are known in the art for measuring the content of ions in biological fluid samples D comprising:
a first half cell provided with a first ion-selective electrode 1 made of a first ion-selective membrane 11 and a first conductive support 12, and a first volume 13 in contact with the first ion-selective membrane 11, this first half-cell forming the so-called reference electrode; and
a second half cell provided with a second ion-selective electrode 2 made of a second ion-selective membrane 21 and a second conductive support 22, and a second volume 23 in contact with the second ion-selective membrane 21, this second half-cell forming the so-called measuring electrode.

In the present description, and as usual in the technical field, each ion-selective electrode is made of a conductive support wherein an ion-selective membrane is deposited, such that membrane potentials can be measured.

Therefore, when the ion-selective membranes are brought in contact with aqueous solutions containing different concentrations of the species to which they are selective, a voltage will appear between the terminals connected to the conductive supports, whenever the circuit is closed between the membranes.

This is done by connecting the first volume and the second volume with a salt bridge 3. The device is completed with means for bringing a biological fluid sample in contact with the second volume. In the particular case of a personal device, these means consist in general in a receptacle, easily identifiable by the user, where he can deposit a drop of the biological fluid, for example blood, or urine.

Many of these devices are disposable, which implies that they are used once by the user, after having been manufactured, handled, stored and sold. However, in these conditions it is impossible to guarantee that the strips are calibrated at the time of using them. This use can occur after several months from manufacturing. Moreover, the manufacturing process itself does not ensure a uniform pre-calibration of the strips, and for this reason they use coding chips with the pre-calibration parameters of each manufactured batch.

As mentioned, the measuring circuit is a closed circuit composed of electric conductors, membrane electrodes and a salt bridge. All these elements are susceptible of variation in time, and thus any one of them can prevent the effectiveness of a calibration in factory.

For overcoming these drawbacks, solutions have been proposed for calibrating the devices just before their only use.

The existing calibration techniques consist mainly in subjecting part of the measuring circuit to known conditions, specifically known concentrations, such that the device/strip can be calibrated. There are two main types of techniques to do so.

In a first type, encapsulated aqueous solutions of known composition are used. In these solutions, the known analytes are driven by a mechanical action to occupy the measuring half-cell, and then the voltage is measured, so that the slope of the characteristic calibration curve of the device can be inferred, at least in the predicted measuring range. These solutions are disclosed for example in the documents EP0672246, WO9002938, U.S. Pat. No. 5,064,618 or EP0282349.

EP0672246 discloses a self-contained, disposable cartridge-type electrochemical test cell for use with an associated reading terminal. More particularly, it discloses a system for controlling and stabilizing the location of a calibration material with respect to the electrode system so that a calibration can be accomplished automatically. The calibration implies the displacement of the calibration medium by the sample readily accommodated.

WO9002938 and U.S. Pat. No. 5,064,618 pose the drawback that they involve gruesome and complex valve and channel system, and that can imply a contamination, with the calibration solution, of the measuring area.

EP0282349 discloses a strip sensor comprising a reference electrode and an ion-selective electrode, where a removable hydrophilic gel layer containing a known concentration of the selected ion bridges the analyte-contacting portions of the electrode for calibration. The calibration implies a dedicated operation for calibration by the user.

A second type of solution is based on using additional electrodes that can be brought in contact with a calibration sample, the concentration of which is known, as for example as disclosed in WO2008029110. Specifically, WO2008029110 discloses a self-calibrating device, which is calibrated using calibration areas that do not coincide with the measuring area. Therefore, here the calibration partially implies a different circuit than the used for detection.

Another drawback of the known devices is that there are important interferences of plasmatic proteins (like lipoproteins or albumin) and blood cells (like erythrocytes, leukocytes and thrombocytes) present in biological fluids that limit the analytical quality parameters (e.g. accuracy, precision, and limit of detection) of the measurements.

### DESCRIPTION OF THE INVENTION

For overcoming the drawbacks of the prior art, the present invention proposes an electrochemical sensing device for measuring the content of ions in biological fluid samples comprising:
a first half cell provided with a first ion-selective electrode made of a first ion-selective membrane and a first conductive support, and a first volume in contact with the first ion-selective membrane;
a second half cell provided with a second ion-selective electrode made of a second ion-selective membrane and a second conductive support, and a second volume in contact with the second ion-selective membrane;
a salt bridge connecting the first volume and the second volume;
means for bringing a biological fluid sample in contact with the second volume;
the salt bridge comprising a diffusion limiter, which allows opening the salt bridge when it is removed,
wherein the first and second membranes are selective to the same ions, and
the first volume and second volume are filled with aqueous solutions of known concentrations of the ions to which the membranes are selective, these known concentrations being different;

such that, after opening the salt bridge by removal of the diffusion limiter, a voltage can be measured between the terminals connected to the first conductive support and the second conductive support, said measured voltage thus allowing calibrating the electrochemical sensing device and then measuring the ion-content of the biological fluid sample.

The term “volume” is herein understood as a closed chamber, able to confine a liquid.

The proposed solution allows determining automatically the parameters that define the calibration equation, specifically its slope and its ordinate at the origin, and thus an easy calibration of the sensing device just before its use. This is particular interesting for disposable devices that are used once, since they can be manufactured, handled, stored and sold in normal conditions without the need of including a calibration step in the manufacturing process.

Moreover, problems associated with the lack of uniformity in the pre-calibration process performed in the manufacture are completely avoided. With the device of the invention, it is guaranteed that the device is calibrated at the time of using, which can be after several months from manufacturing.

Moreover, the calibration is done just before measuring without requiring additional materials or reagents or knowledge of the user, but only by means of an internal process of the sensing device itself. For example, the use of a coding chip is completely avoided. Thus, the sensing device is especially useful as disposable device for final users or patients, i.e. which are not technical staff or physicians. Therefore, the proposed device allows not just a “pre-calibration” but an automatic calibration at the time of using, thus making possible to use the device by a non-experienced user. There is no action by the user; in fact, the end user will not even notice that the device is being calibrated.

From the manufacturing point of view, there is no need for a perfectly reproducible manufacturing process allowing to use common calibration parameters for every batch of manufactured devices.

Otherwise said, according to the present invention, the calibration circuit and the measuring circuit are the same. In this way, the calibration takes into account all the components, such that any deviation will be considered in the calibration process. This is not possible with devices making use of a calibration circuit arranged in parallel.

Therefore the invention provides a portable, and preferably disposable, user-operable electrochemical sensor device for self-measuring and monitoring the content of ions in biological fluid samples.

Advantageously, the proposed device provides an accurate quantitative determination of the ions of interest in the biological sample, as required for example by pathologies associated with amounts of such ions.

Moreover, only one technology is used for the manufacture of the electrodes. That is, two electrodes selective of the ion to be analysed are used, one acting as a reference and the other as an indicator, instead of using on the one hand a selective electrode of the analyte to be determined and on the other hand a classical reference electrode (e.g. Ag/AgCl or Saturated Calomelans Electrode SCE). Thus, the manufacturing is simplified, and hence the costs lowered.

Therefore, for example, with the inventive device it is possible to:
Obtain accurate and precise quality measurements performed at the patient's own home;
Get information immediately in real time;
Reduce costs for the health system in chronic patients;
No need of experienced staff;
Comprehensively control the evolution of a parameter linked to a pathology of a patient (telemedicine);
Efficiently treat chronic pathologies, i.e. greater speed in detecting and acting against imbalances in some parameters of the patient allowing him to self-adjust doses;
In general, improvement of the quality of life of the chronic patient.

By ‘opening the salt bridge’ it is understood putting in fluid communication the two ends of the salt bridge.

The diffusion limiter allows delaying or avoiding the conduction of ions through the salt bridge, hence allowing maintaining the aqueous solutions of known concentrations stable until the diffusion limiter is removed by the user.

In some embodiments, the difference of ion concentration between the known concentrations is at least a decade.

However, the difference can be greater depending on the range of concentrations in the sample of the ion to be analysed. Actually, the optimal difference is the one that covers a little more than the concentration corresponding to the range that is intended to study in the sample. Preferably, the concentration of one of the volume being lower or equal to the lower concentration of the ion to be measured that can be found in the sample. It should also be pointed out that the smaller the difference between the concentrations, the lower diffusion gradient and therefore more time lapses between the removal of the diffusion limiter and the measurement.

In some embodiments, the diffusion limiter is mechanical, thermal or chemical. In other embodiments the diffusion limiter is a labyrinth shaped salt bridge.

The mechanical diffusion limiter can be a mechanically operated lancet that breaks a membrane separating the two sides of the salt bridge, thus bringing the aqueous solutions of known concentration filling the first and second volumes in contact at the time of measurement.

The thermal diffusion limiter can be a wax that insulates both sides of the salt bridge and at the moment of measurement, melts by applying heat, putting the aqueous solutions of known concentration filling the first and second volumes in contact.

The chemical diffusion limiter can be an ionic liquid, specifically an aqueous solution immiscible with the solution composing the salt bridge, which in principle would not allow diffusion through it but could act as a salt bridge due to its ionic nature.

In some embodiments, the means for bringing a biological fluid sample in contact with the second volume comprise a sample inlet, which connects the outside with the second volume. Preferably, there is a reservoir volume between the inlet and the second volume, such that when this reservoir is completely filled with the sample, no more sample is allowed to enter, thus enabling to control the amount of sample.

In some embodiments, the electrochemical sensing device comprises a gas diffusion layer (membrane) in the sample inlet, such that the sample must cross it to reach the second volume.

In some embodiments, the ion selective membranes are made of a polymer support (e.g. polyvinyl chloride, PVC) with a plasticizer, preferably a lipophilic plasticizer (e.g. nitrophenyloctylether, NPOE; dioctylsebacate, DOS), which plasticizes the polymer and solubilizes or immobilizes the compounds (i.e. ionophores) that selectively interact with the ions to be measured. The resulting ion selective membrane is hydrophobic. The selective membrane can also comprise ionic additives in order to reduce interferences from counterions, improve the extraction kinetics and reduce response time.

The first and second volumes in contact with the membranes and the channel connecting them, acting as a salt bridge, are filled with aqueous solutions of known concentration of the analyte to be measured. In a particular embodiment, said solutions are aqueous solutions and are embedded in a hydrated solid or in a hydrated salt. More particularly, the aqueous solutions are embedded in a hydrogel. The use of a hydrogel has the advantages of embedding the aqueous solutions, thus stabilizing them, and at the same time, performing the function of a saline bridge and a tuneable diffusion barrier.

A hydrogel is a network of polymer chains that are hydrophilic, sometimes found as a colloidal gel in which water is the dispersion medium. Hydrogels are highly absorbent (they can contain over 90% water) natural or synthetic polymeric networks. Hydrogels confers flexibility and stability to aqueous solutions embedded into it. Their hydrophilic structure renders them capable of holding large amounts of water and water solutions in their three-dimensional networks. Examples of hydrogels are agarose, polyacrylamide, polyvinyl alcohol, polyurethanes, methyl poly methacrylate, polyethylene, polyvinylpyrrolidone, poly 2-hydroxyethyl methacrylate, poly N-vinyl pyrrolidone, poly acrylic acid, polyethylene glycol, poly methacrylic acid, polylactic acid (PLA), polyglycolic acid (PGA), poly (lactic-co-glycolic acid) (PLGA), polyanhydrides or polyesters. In a particular embodiment, the hydrogel is 1% agarose. Additionally, the aqueous solutions with predetermined concentrations of the analyte embedded in the hydrogel can comprise other ions different from those to be measured, and pH or ionic strength adjusters (e.g. a buffer such as tris(hydroxymethyl)aminomethane, TRIS buffer).

In some embodiments, the conductive supports are made of a conductive metal, composite conductive polymer filled with metallic nanoparticles, graphite, carbon nanotubes, graphene, conductive polymer or a conductive ink.

In some embodiments, the electrochemical sensing device is formed by the following layers:
a bottom enclosing layer;
the conductive supports and the measuring terminals;
a first intermediate enclosing layer provided with through holes for housing the membranes, and cuts for accessing the measuring terminals;
a second intermediate enclosing layer comprising a through hole that defines two housings for the first volume and the second volume and, a channel that connects the housings and which houses the salt bridge and cuts for accessing the measuring terminals; and
a top enclosing layer comprising a through hole for depositing the biological fluid sample and cuts for accessing the measuring terminals.

According to a second aspect, the invention refers to an electrochemical sensing device for measuring the content of ions in biological fluid samples comprising:
a first half cell provided with a first ion-selective electrode made of a first ion-selective membrane and a first conductive support;
a second half cell provided with a second ion-selective electrode made of a second ion-selective membrane and a second conductive support;
a salt bridge connecting first ion-selective membrane and the ion-selective membrane;
means for bringing a biological fluid sample in contact with the salt bridge in the vicinity of the ion-selective membrane;

wherein that the first and second membranes are selective to the same ions, and which comprises a first calibration volume with a known concentration of the ions to which the membranes are selective, the calibration volume being placed in contact with the salt bridge in the vicinity of the first ion-selective membrane, the salt bridge being filled with a known concentration of the ions to which the membranes are selective, and which comprises a diffusion limiter between the calibration volume and the salt bridge, such that a voltage can be measured between the first electrode and the second electrode that allows calibrating the electrochemical sensing device, when the diffusion limiter is removed, and then measuring the ion-content of the biological fluid sample.

Preferably, the electrochemical sensing device according to the second aspect comprises a second calibration volume with a known concentration of the ions to which the membranes are selective, the second calibration volume being placed in contact with the salt bridge in the vicinity of the second ion-selective membrane.

Any of the aforementioned inventive electrochemical sensing devices can be preferably configured as a strip.

The invention also refers to a method for measuring the content of ions in biological fluid samples by using the electrochemical sensing device according to any of the variants disclosed above, which comprises the steps of:

a) measuring the voltage between the first half cell and the second half cell for calibrating the device in order to determine the calibration equation;

b) placing a biological fluid sample in contact with the second volume;

c) measuring the voltage between the first half cell and the second half cell after a sufficient time has lapsed for the ions of the fluid sample to diffuse into the second ion-selective membrane such that a stable measure can be taken; and

d) determining the ion concentration in the biological fluid sample.

Preferably, step a) will be carried out after a previous step consisting in removing the diffusion limiter of the salt bridge or the diffusion limiter(s) of the calibration volume(s).

Preferably, step a) and the previous step of removal of the diffusion limiter are carried out after coupling the electrochemical sensing device to a reading terminal. Therefore, the present invention takes advantage of the fact that the user has to insert the device in a reading terminal. Then, while inserting, a particular arrangement of the receiving slot can be used to remove the diffusion limiter(s).

Finally, according to a fourth aspect, the present invention relates to an electrochemical sensing device for measuring the content of ions in biological fluid samples comprising:
a first half cell provided with a first ion-selective electrode made of a first ion-selective membrane and a first conductive support, and a first volume in contact with the first ion-selective membrane;
a second half cell provided with a second ion-selective electrode made of a second ion-selective membrane and a second conductive support, and a second volume in contact with the second ion-selective membrane;
a salt bridge connecting the first volume and the second volume; and
means for bringing a biological fluid sample in contact with the second volume,

wherein the salt bridge comprises a diffusion limiter, which allows opening the salt bridge when it is removed, and wherein the first volume, the second volume and the salt bridge are a hydrogel.

Hydrogels, besides allowing liquids confinement to prevent accidental leaks, can have also an active function in the measurement process. They restrict or remove the negative effect of interfering substances through their polymeric lattice nature. In this case, the hydrogel functions as a barrier to the molecules, which diffuse through it. Thus, the smaller molecules, the ions to be measured among them, will diffuse faster and the larger ones, including both the lipophilic compounds and the blood cells carried by the biological fluid, will be retained or delayed by the polymer framework, and will reach the sensor after the measurement is performed. The skilled person can control the difference in the speeds, or the delay, by adequately choosing a certain mass percentage of polymer in the hydrogel and a certain hydrogel layer thickness to be travelled.

For example, considering the specific case of Li⁺ (Lithium ion) determination in biological samples with a lithium selective electrode, the deposition of a hydrogel with a certain percentage of polymer and thickness, between the electrode and the sample, will allow the ions to reach the sensing surface earlier than the possible matrix interfering compounds such as proteins or other voluminous biological compounds. Many of these compounds have a lipophilic character and can be adsorbed onto the surface of the ion selective polymeric membrane and thus, alter the signal response.

In conclusion, according to this further aspect of the invention, it is possible to overcome some common surface passivation problems that arise in such type of sensors by using a hydrogel between the sample and the sensor surface.

The proposed electrochemical sensing device in its different aspects and embodiments as previously described, is useful for measuring the content of ions in fluid samples. The sensing devices are useful especially in the area of so-called point-of-care testing and home or domestic monitoring, but they have other applications like water analysis—also in space missions-, environmental monitoring, food analysis (dairy products, wine) and safety, industrial process control, and chemical/biochemical research, among others.

Ions of particular interest are medically relevant ions, i.e. those being involved or being biological markers of human disease or states. Non-limitative examples of ions of interest are the following:

NH₄⁺ (Ammonium ion), associated with hyperammonemia (disorders in the urea cycle);

Li⁺ (Lithium ion), associated with mental disorders (e.g. bipolar disorder);

K⁺ (Potassium ion), associated with hyperkalemia (renal dysfunction);

Na⁺ (Sodium ion), associated with hypernatremia (dehydration associated with various pathologies);

Ca²⁺ (Calcium ion), associated with hypercalcemia (parathyroid gland dysfunction);

NO₃⁻ (Nitrate ion), associated with methemoglobinemia;

Cl⁻ (Chloride ion), associated with hyperchloremia in dehydration, renal failure, diabetes, etc;

H⁺ (Hydrogen ion), associated with all acid-base equilibriums in biological fluids;

HCO₃⁻—H₂CO₃ (CO_{2 gas})), (bicarbonate ion—Acid Carbonic (Carbon dioxide)), related to different diseases.

Therefore the electrochemical sensing device is useful in the diagnosis, prognosis and regular monitoring of these diseases or states. Particularly, the sensing device is useful in the point-of-care testing at the hospital and in the self-monitoring testing, also so-called home or domestic monitoring.

Another aspect of the invention relates to the use of the proposed electrochemical sensing device in measuring the content of ions in a biological fluid sample.

In a particular embodiment, the ion to be measured is Ammonium ion. In another particular embodiment, the ion to be measured is Lithium ion.

All the aforementioned ions, e.g., Li⁺, with the exception of NH₄⁺ and CO₃²⁻/HCO₃⁻, which can be converted into gases, follow the measuring process with the device of the invention as described above. Thus, the device does not comprise gas diffusion membrane and the hydrogel minimizes the interferences from the sample matrix. The skilled in the art will adapt the sensing device according to the ion to be measured; for example, they will adapt the composition in percentage of the hydrogel polymer and the thickness thereof and the aqueous solution embedded in this hydrogel (with pH adjusters, other ions than the analyte, different concentrations of the analyte itself, etc). On the other hand, a particular embodiment of the sensing device for measuring ions which can be converted into gases such as NH₄⁺ (Ammonium ion) and CO₃²⁻/HCO₃⁻, is described below in the section of description of a way of carrying out the invention and in FIG. 3 and FIG. 6.

Although the sensing device makes a potentiometric measurement, i.e. based on a difference in electric potential due to charge species, it can also be used to perform indirect measurements of neutral molecules and charged or neutral complexes included in a fluid sample. Examples of relevant molecules are glucose, creatinine, phenylalanine, etc. This can be performed e.g. by introducing a treatment step before measuring, to transform the uncharged molecule into a charged one (e.g. measuring CO₂ by means of measuring bicarbonate) or the charged or neutral complexes into an uncomplexed ion, or by indirectly measuring an ionic product resulting from that molecule (e.g. measuring ammonium ion as result of the enzymatic reaction of phenylalanine—the analyte of interest in this case-). It can also be used to measure the amount of enzyme or substrate as analyte, by having the recognition element (substrate or enzyme) suitable for the analyte to be measured in the selective membrane or on a support. In some cases, additional membranes or layers can be needed.

In a particular embodiment, the sensing device is used to measure phenylalanine amounts in blood for example. Phenylalanine is a relevant metabolite/biomarker in diseases of phenylalanine metabolism like phenylketonuria. Phenylketonuria is a genetic disorder inherited from a person's parents. It is due to mutations in the PAH gene which results in low levels of the enzyme phenylalanine hydroxylase (PAH). This results in the buildup of dietary phenylalanine to potentially toxic levels. Phenylalanine measurement with the present sensing device can be performed by indirectly measuring Ammonium ion as result of the enzymatic conversion of phenylalanine into trans-cinnamic acid and Ammonia through PAL enzyme (Phenylalanine Ammonia-Lyase). This measurement is currently performed by automated enzymatic detection by spectrophotometric measurement in the hospital laboratory. The sensing device according to the invention allows phenylalanine monitoring at home.

In a particular embodiment, the sensing device is used to measure urea amounts in blood for example. Urea is a relevant metabolite/biomarker in many diseases such as urea cycle disorders. Urea measurement with the present sensing device can be performed by indirectly measuring Ammonium ion as result of the enzymatic conversion of urea into CO2 and Ammonia through urease enzyme.

The fluid sample is particularly a biological fluid sample and can be for example blood, urine, saliva or sputum. It can also be a gas, for instance to be used in a breath test.

As said before, besides ions and molecules of medical significance, the electrochemical sensing device is also useful in other areas such as agriculture and environment, e.g. in the monitoring of ions in river water.

### BRIEF DESCRIPTION OF THE DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1 is a schematic cross-section of an already existing sensing device.

FIG. 2 is a schematic cross-section of a sensing device according to an embodiment of the invention, wherein the salt bridge is already composed of volumes with different ion concentrations.

FIG. 3 is a schematic cross-section of a sensing device according to an embodiment of the invention, which comprises a gas membrane, specially adapted to measure the NH₄⁺ (Ammonium ion) content.

FIG. 4 is a schematic cross-section of a sensing device according to another embodiment of the invention, wherein calibration volumes can be brought in contact with the ends of the salt bridge.

FIG. 5 is an exploded perspective view of an embodiment of the invention based in a layered design.

FIG. 6 is analogous to FIG. 5, but it shows an embodiment provided with a gas membrane.

FIG. 7 shows a sequence of diffusion of ions through a salt bridge.

FIG. 8 shows a sequence of diffusion of ions through a tortuous salt bridge, which slows down the diffusion.

FIG. 9 shows an experimental device used in the calibration experiment.

FIG. 10 shows the experimental arrangement used for demonstrating the viability of the inventive sensor.

FIG. 11 is a graph of the experimental data.

FIG. 12 Time evolution graph of the response of a sensor using hydrogel as a barrier to delay signal interfering substances.

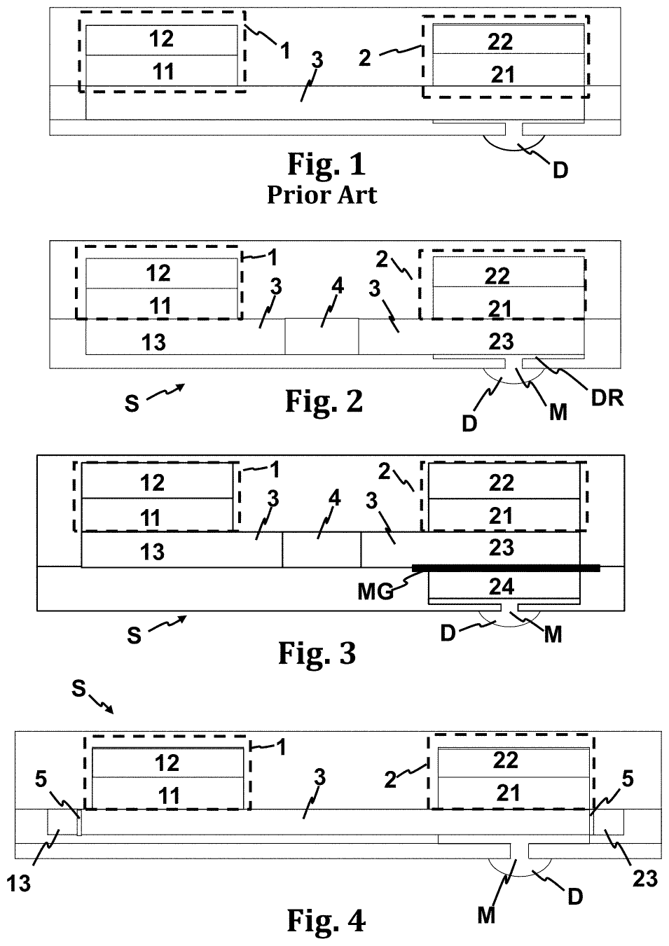

### DESCRIPTION OF WAYS OF CARRYING OUT THE INVENTION

FIG. 2 depicts a preferred embodiment of the electrochemical sensing device S for measuring the content of ions in biological fluid samples D, which comprises two half-cells 1, 2, one of which will play the role of the reference half-cell, and the other of which will play the role of the measuring or indicator half-cell.

The first half cell comprises a first ion-selective electrode 1 in turn made of a first ion-selective membrane 11 and a first conductive support 12 (both components enclosed in a dashed line rectangle), and a first volume 13 in contact with the first ion-selective membrane 11.

Accordingly, the second half cell comprises a second ion-selective electrode 2 made of a second ion-selective membrane 21 and a second conductive support 22, and a second volume 23 in contact with the second ion-selective membrane 21.

In all the embodiments, a salt bridge 3 connects the first volume 13 and the second volume 23, thus closing the sensing circuit.

The device is completed with means for bringing a biological fluid sample D in contact with the second volume 23, which in this case is a receptacle connected with the second volume through a sample inlet M.

According to the invention, the first and second membranes 11, 21 are selective to the same ions and the first volume 13 and second volume 23 are filled with known concentrations C1, C2 of the ions to which the membranes 11, 21 are selective, these known concentrations being different.

In this way, it is possible to measure a voltage between the first electrode 12 and the second electrode 22 that allows calibrating the electrochemical sensing device S prior to measuring the ion-content of the biological fluid sample D.

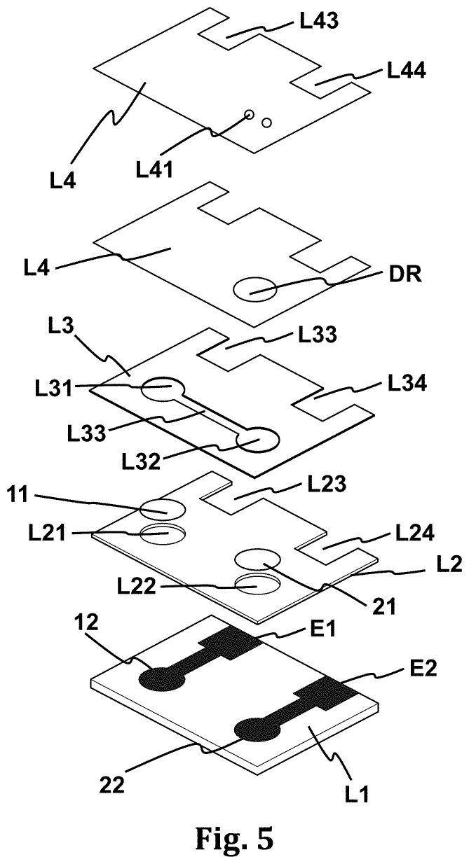

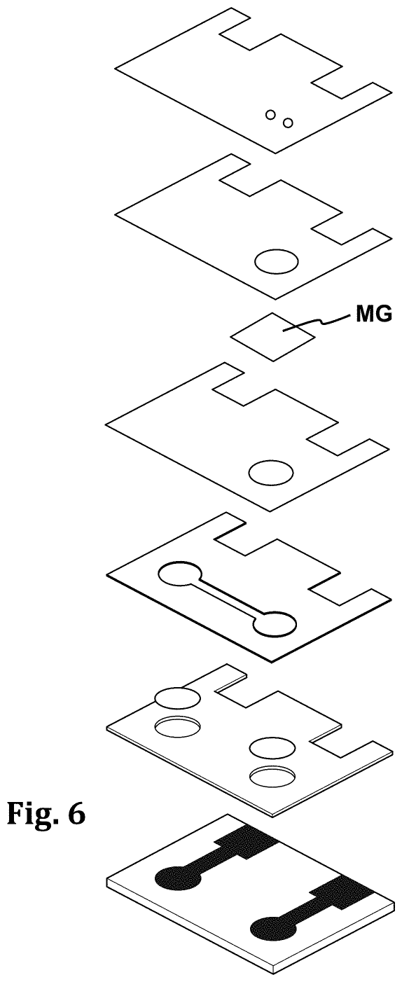

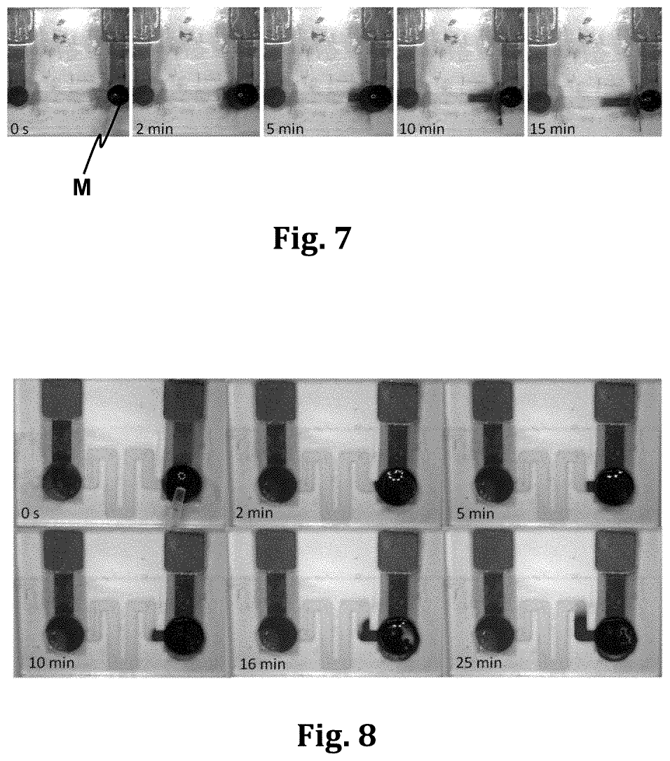

The device works as shown in FIGS. 7 and 8. The details of the materials forming the device are specified below in relation to FIGS. 5 and 6.

At a time t=0 s the drop D is deposited on the inlet M. First, the analyte diffuse through the volume 23 and reaches the membrane 21. Then the measurements start. In the meanwhile, the analyte diffuses through the salt bridge, and while the analyte has not reached the volume 13, the measurements are taken. This allows the concentrations to stabilize and the reading terminal, where the device is inserted, can identify the plateaus and then, determine the concentrations. The analysis time usually lasts no longer than 5 min, so it is ensured that the ions will never reach volume 13.

The plateaus are the zones, where the voltage measured stabilizes in a voltage vs time graph.

In the right picture of FIG. 7 it is shown that after 15 min there is still time remaining for measuring, since the analyte front has only travelled 40% of the whole bridge.

As seen in FIG. 8, where the times are indicated, a diffusion limiter based on a labyrinth allows slowing down the diffusion, and then better controlling the time windows for the measurements.

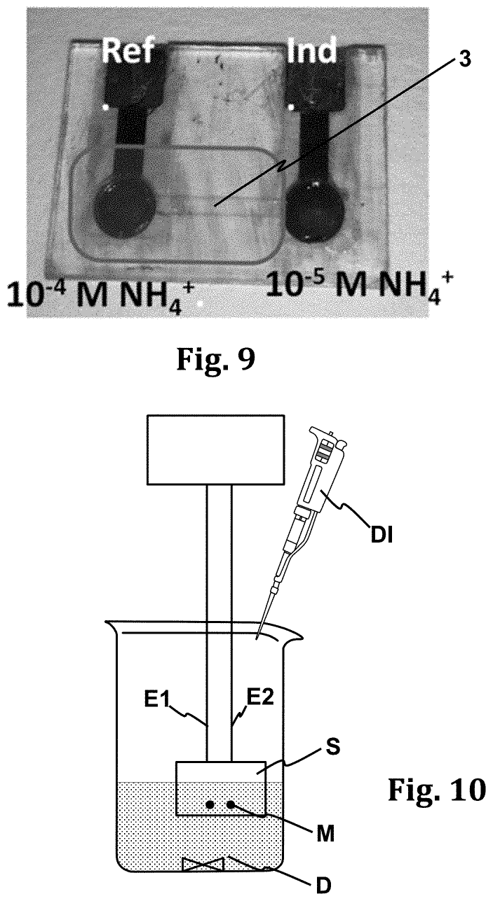

FIGS. 9 to 11 illustrate an experiment carried out to demonstrate the viability of the inventive device.

The experiment, as shown in FIG. 10, makes use of a recipient with a liquid sample, the concentration of which can be accurately controlled via the dispenser DI. The device S is connected to a potentiometer through the terminals E1 and E2.

FIG. 9 shows the device S used for the experiment, which is shown partially submerged in FIG. 10, and where the reference half-cell (Ref) has been covered, such that only the indicator or measurement electrode (Ind) will be accessible for the sample D, through the inlet M. In the experiment, the sample is part of the liquid contained in the recipient, and it is supposed to have the same concentration (i.e., the liquid is uniform).

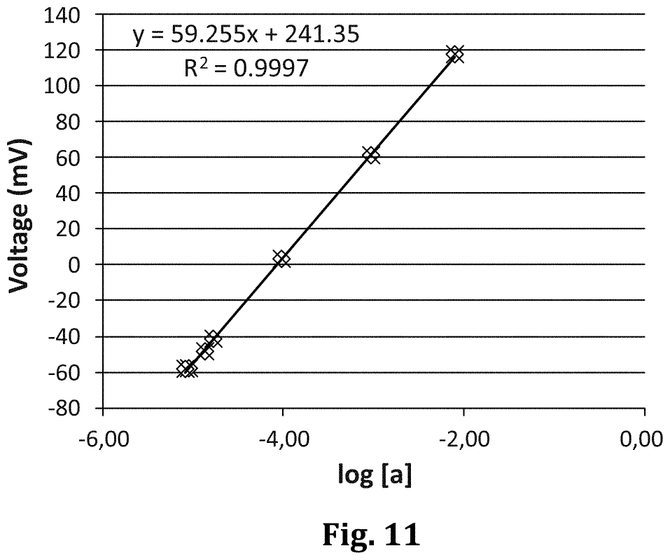

Then, before the analyte has reached the reference membrane, by travelling through the salt bridge 3, the concentration of the analyte D is varied by adjusting it with the dispenser DI. A stepped voltage graphic (a graphic with plateaus corresponding to stable concentrations in the volume 23) is obtained where the voltages are collected: The latter represented in the graphic shown in FIG. 11.

The graphic of FIG. 11 shows the strong linear correlation between the logarithm of the concentration and the voltage, and thus the viability of the inventive sensor.

As an example, the calibration and measurement process is as follows:

First, a device comprising a diffusion limiter 4 (or 5) if conceived with calibration volumes apart) is manufactured in factory.

The Nernst equation applies to such device, namely:

E=a+b·log[NH₄⁺]

Where, theoretically for Ammonium ion b=59.2 mV/decade.

Then the device is packaged, stored and distributed. Then, days, weeks or months later, the user unpacks it and couples it to a reading terminal. When coupling, preferably, the diffusion limiter 4 (or 5) will be removed, and then the measuring circuit will be electrically closed. Then the measurements will start.

So, in factory the different concentrations of the ion to be measured are those as shown in FIG. 9, 10⁻⁴ in the first volume 13 and 10⁻⁵ M in the second volume 23.

Then, for example, the potentiometer indicates −55.8 mV, instead of the theoretical value mentioned above. This difference is only due to the different concentrations already prepared in factory. The user has still not dropped its sample.

Starting from this value, the pre-calibration model yields:

−55.8=a+b·log[10⁻⁵]−(b·log[10⁻⁴]+a)

−55.8=b·(log[10⁻⁵]−log[10⁻⁴])

b=55.8 mV

−55.8=55.8·log[10⁻⁵]+a

a=223.2

And thus: E=55.8·log[NH₄⁺]+223.2

Then the user places a blood drop, and after 1 or 2 minutes, that is, when an equilibrium has been reached, the potentiometer could for instance indicate −38 mV.

Then, assuming that the hydrogel volume equals the volume of the sample (i.e. thanks to the volume of the dosing reservoir DR interposed between the inlet M and the volume 23):

[NH₄⁺]═(C_{hydrogel}+Cₛₐₘₚₗₑ)/2

The concentration of Ammonium ion measured is:

−38=55.8·log[NH₄⁺]+223.2

[NH₄⁺]=2.1·10⁻⁵ M

And then, the concentration of Ammonium ion in blood is:

[NH₄⁺]ₛ=(10⁻⁵+Cₛₐₘₚₗₑ)/2;

Cₛₐₘₚₗₑ=3.2·10⁻⁵M

According to the preferred embodiment of the invention, the salt bridge 3 comprises a diffusion limiter 4, which allows opening the salt bridge 3 when it is removed.

Therefore, the diffusion limiter 4 is a component that can delay the connection between the two ends of the bridge.

According to a practical implementation, the electrochemical sensing device is formed by the following layers, as shown in FIGS. 5 and 6:
a bottom enclosing layer L1; In a practical embodiment, this layer (1 mm thick) could be COC (Cyclic Olefin Copolymer, a thermoplastic polymer). It has a 300 μm bas-relief on the upper surface, where the conductive supports 12, 22 and the measuring terminals E1, E2 (which made up the conductive layer) are deposited, for example by screen-printing;
a first intermediate enclosing layer L2 provided with through holes L21, L22 for housing the selective membranes 11, 21, and cuts L23, L24 for accessing the measuring terminals E1, E2. This layer is a 300 μm COC layer;
a second intermediate enclosing layer L3 comprising a through hole, which defines two housings L31, L32 for the first volume 13 and the second volume 23 and a microchannel L33, which connects the housings L31, L32 and that houses the salt bridge 3 and cuts L33, L34 for accessing the measuring terminals E1, E2. This layer (100 μm thick) is also COC. For example, to determine ammonium ion content, 0.01 M TRIS buffer pH 7.4 with 10⁻⁵ M ammonium ion is used for the salt bridge 3 (microchannel between housings) and in the L32 chamber (indicator electrode) whereas 0.01 M TRIS buffer pH 7.4 with 10⁻⁴ M ammonium ion is used in the left chamber (reference electrode).
a top enclosing layer L4 comprising a through hole L41 for depositing the biological fluid sample D and cuts L43, L44 for accessing the measuring terminals E1, E2. This layer is also formed by Cyclic Olefyn Copolymer. As seen, the sample inlet is divided in two holes, one for the introduction, by capillarity, of the sample and another to evacuate the air. There is another intermediate layer, which defines the dosing reservoir DR, so that when the sample is deposited on one of the holes, it enters the sample dosing reservoir DR and once there, that is, with the volume of sample to be analyzed defined, the analyte is diffused through the volume 23.

Obviously, any other plastic that meets the manufacturing needs of the device could be used.

As shown in FIGS. 3 and 6, the electrochemical sensing device can comprise a gas diffusion layer (membrane) MG between volumes 24 and 23, such that when the drop of sample enters through the inlet M and reaches the volume 24, the analyte to be determined reacts with the reagents present in volume 24 in order to form a gas compound, which is the only one able to diffuse through the MG and reach the volume 23, where it reacts with another reagents present in volume 23 to recover the original form, which can be measured by the electrode 2.

This procedure allows a highly selective measurement but can be applied only with analytes showing acid-base properties and in which one of these forms is a gas.

For example, considering the specific case of NH₄⁺ (Ammonium ion) determination in biological samples with an ammonium selective electrode, when the sample is introduced through the inlet M, it reaches the volume 24, which contains a hydrogel with a basic pH (NaOH). Ammonia gas is formed from ammonium ion, which diffuses through the MG reaching the volume 23. Volume 23 is a hydrogel with a trishydroxymethyl aminomethane (TRIS) buffered solution set to pH 7.4, so that the ammonia gas is converted again to ammonium ion, which can be determined by the ammonium selective electrode 2.

Obviously, the only way to the inside of the device must be this access, that is the sample inlet, for the sample (blood) drop, and all the remaining volumes should be correctly encapsulated to guarantee stability and avoid biohazards.

The sensing device shown in FIG. 3 was used to measure ammonia amounts in blood. Ammonia is a relevant metabolite/biomarker in many diseases such as urea cycle disorders. The composition of the hydrogel used was 1% of agarose and 99% of a buffered dissolution of Tris 0.01M at pH 7.4 with 10 μM NH₄+, filling the volumes 23 and 13. The volume 24 was filled using a dissolution of NaOH 0.1 M. The response time was 4 min. Volumes of 1 μL of standard dissolutions of Li+ of increasing concentration were added. The linear range obtained was 75-1564 μmol/L NH₄+(threshold to discriminate between a normal and a pathological ammonium concentration is 60 μmol/L in adults and 75-100 μmol/L in newborns, over 200 μmol/L can cause severe consequences such as mental illness or dead) thus proving that the device is useful to determine toxic amounts of ammonia in blood samples.

This device was also used to measure urea amounts in blood. Urea is also a relevant metabolite/biomarker in many diseases such as urea cycle disorders. Urea measurement with the present sensing device can be performed by indirectly measuring Ammonium ion as result of the enzymatic conversion of urea into CO₂ and Ammonia through urease enzyme. The composition of the hydrogel used was 1% of agarose and 99% of a buffered dissolution of Tris 0.01M at pH 7.4 with 100 μM NH₄+, filling the volumes 23 and 13. The volume 24 was filled using a dissolution of urease 0.66 mg/ml. The response time was 4 min. Volumes of 1 μL of standard dissolutions of Li+ of increasing concentration were added. The linear range obtained was 325-2260 μmol/L NH4+ being enough to determine its concentration in real blood samples (around 2000 μmol/L).

According to another embodiment, shown in FIG. 4, the electrochemical sensing device S for measuring the content of ions in biological fluid samples D comprises:
a first half cell provided with a first ion-selective electrode 1 made of a first ion-selective membrane 11 and a first conductive support 12;
a second half cell provided with a second ion-selective electrode 2 made of a second ion-selective membrane 21 and a second conductive support 22;
a salt bridge 3 connecting first ion-selective membrane 11 and the ion-selective membrane 21;
means for bringing a biological fluid sample D in contact with the salt bridge 3 in the vicinity of the ion-selective membrane 21; where the first and second membranes 11, 21 are selective to the same ions, and which comprises a first calibration volume 13, which is filled with an aqueous solution with a known concentration C1 of the ions to which the membranes 11, 21 are selective, the calibration volume 13 being placed in contact with the salt bridge 3 in the vicinity of the first ion-selective membrane 11, the salt bridge 3 being filled with a known concentration C2 of the ions to which the membranes 11, 21 are selective, and which comprises a diffusion limiter 5 between the calibration volume 13 and the salt bridge 3, such that a voltage can be measured between the first electrode 12 and the second electrode 22 that allows calibrating the electrochemical sensing device S when the diffusion limiter 5 is removed, and then measuring the ion-content of the biological fluid sample D.

Optionally, the sensing device, based in calibration volumes different from the salt bridge, comprises a second calibration volume 23 with a known concentration C2 of the ions to which the membranes 11, 21 are selective, the second calibration volume 23 being placed in contact with the salt bridge 3 in the vicinity of the second ion-selective membrane 21.

Both variants of the inventive sensing device allow carrying out a method which comprises the steps of:

previously removing the diffusion limiter 4 of the salt bridge 3 in the case of the first embodiment, or breaking the seals 5 in the case of the second embodiment;

a) measuring the voltage V_{CAL} between the first half cell 1 and the second half cell 2 for calibrating the device S in order to determine the calibration equation;

b) placing a biological fluid sample D in contact with the second volume 23;

c) measuring the voltage V_{SAMP} between first half cell 1 and the second half cell 2 after a sufficient time has lapsed for the ions of the fluid sample D to diffuse into the second ion-selective membrane 21 such that a stable measure can be taken; and

d) determining the ion concentration in the biological fluid sample D.

The steps of removing the diffusion limiter 4 or breaking the seals 5, and step a) are carried out after coupling the electrochemical sensing device S to a reading terminal or reading platform, and preferably the removal of the diffusion limiter 4 or the seals 5 will be done automatically during this coupling step, such that the user will not have to worry about it. This can be done, for example, by displacing a lancet that will open the communication between the two sides of the salt bridge 3. The reading terminal can have a protrusion in its coupling slot that induces a force on the coupling end of the sensing device, where the lancet is placed. Another possibility is to place a thermal source in the slot of the reading terminal such that it heats a thermal diffusion limiter 4, for example a wax, and melts it, thus initiating the calibration process.

The invention also relates to an electrochemical sensing device S for measuring the content of ions in biological fluid samples D comprising:
a first half cell provided with a first ion-selective electrode 1 made of a first ion-selective membrane 11 and a first conductive support 12, and a first volume 13 in contact with the first ion-selective membrane 11;
a second half cell provided with a second ion-selective electrode 2 made of a second ion-selective membrane 21 and a second conductive support 22, and a second volume 23 in contact with the second ion-selective membrane 21;
a salt bridge 3 connecting the first volume 13 and the second volume 23; and
means for bringing a biological fluid sample D in contact with the second volume 23, and wherein the salt bridge 3 comprises a diffusion limiter 4, which allows opening the salt bridge 3 when it is removed, and wherein the first volume 13, the second volume 23 and the salt bridge are a hydrogel.

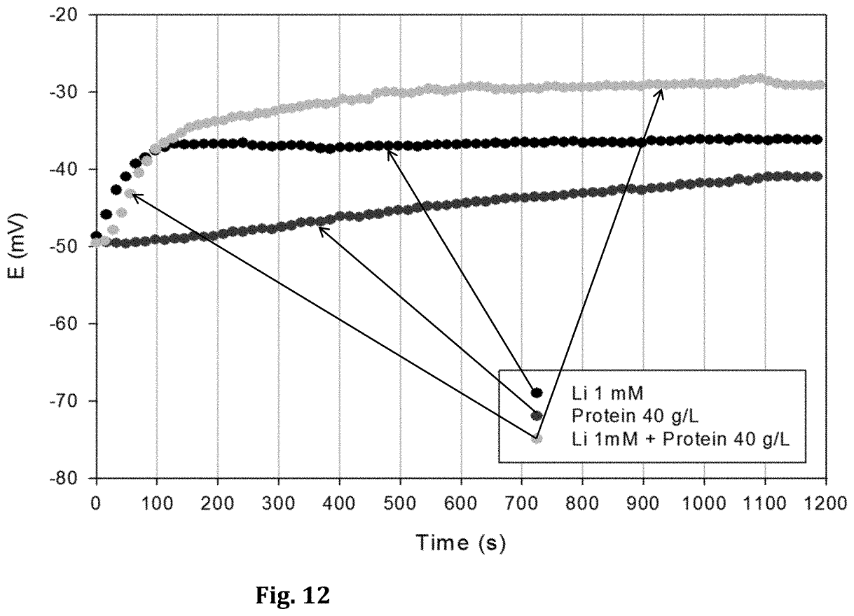

This device has been used with a hydrogel having a composition of 1% of agarose and 99% of distilled water and the results depicted in FIG. 12 were obtained.

Herein, three data series are shown. The first one (black dots) corresponds to the addition of a pure dissolution of 1 mM Li+(Sigma-Aldrich). It takes up to 100 seconds to reach the maximum potential. The second data series (dark grey dots) corresponds to an addition of a 40 g/L BSA (Roche) dissolution simulating the plasma protein medium. The protein takes longer to reach the sensor, making the E grow more slowly. Finally, the light grey series corresponds to an addition of a solution of Li+ and BSA, simulating a synthetic sample of plasma. As it can be seen, at 100 s the maximum potential corresponding to Li+ is reached, so the E value corresponding to that time should be taken. If we wait longer, proteins will reach the sensor and that will cause an increase of the potential, causing an overestimation of Li+ concentration. This means that if the potential is measured at any time before 100 s, the measurement will be free of the interference of the proteins, thanks to the “filtering” effect of the hydrogel. In any case, the values of E to reach the desired limit of detection have to be taken into account. This result is positive for the utility of the sensing device, because the measurement by the final user will be within this time.

In this text, the term “comprise” and its derivations (such as “comprising”, etc.) should not be understood in an excluding sense, that is, these terms should not be interpreted as excluding the possibility that, what is described and defined, may include further elements, steps, etc. On the other hand, the invention is obviously not limited to the specific embodiment(s) described herein, but also encompasses any variations that may be considered by any person skilled in the art (for example, as regards the choice of materials, dimensions, components, configuration, etc.), within the general scope of the invention as defined in the claims.

1. An electrochemical sensing device for measuring the content of ions in a biological fluid sample comprising:
a first half cell provided with a first ion-selective electrode made of a first ion-selective membrane and a first conductive support, and a first volume in contact with the first ion-selective membrane;
a second half cell provided with a second ion-selective electrode made of a second ion-selective membrane and a second conductive support, and a second volume in contact with the second ion-selective membrane;
a salt bridge connecting the first volume and the second volume; and
means for bringing a biological fluid sample in contact with the second volume;
wherein:
the salt bridge comprises a diffusion limiter, which allows opening the salt bridge when it is removed;
wherein the first and second membranes are selective to the same ions; and
the first volume and second volume are filled with aqueous solutions of known concentrations of the ions to which the membranes are selective, these known concentrations being different;
such that, after opening the salt bridge by removal of the diffusion limiter, a voltage can be measured between the first conductive support and the second conductive support, said measured voltage thus allowing calibrating the electrochemical sensing device and then measuring the ion-content of the biological fluid sample.

2. The electrochemical sensing device according to claim 1, wherein the difference of ion concentration between the aqueous solutions of known concentrations comprises the range of concentrations to be measured.

3. The electrochemical sensing device according to claim 1, wherein the diffusion limiter is mechanical, thermal or chemical.

4. The electrochemical sensing device according to claim 1, wherein the means for bringing a biological fluid sample in contact with the second volume comprise a sample inlet, which connects the outside with the second volume.

5. The electrochemical sensing device according to claim 4, which comprises a gas diffusion layer in the sample inlet, such that the sample must cross it to reach the second volume.

6. The electrochemical sensing device according to claim 1, wherein the ion selective membranes are made of a polymer with a plasticizer in which the compounds that selectively interact with the ions to be measured are dissolved or immobilized.

7. The electrochemical sensing device according to claim 1, wherein the first volume and second volumes and the salt bridge are filled with aqueous solutions of known concentrations embedded in a hydrogel.

8. The electrochemical sensing device according to claim 1, wherein the conductive supports are made of a conductive metal, composite conductive polymer filled with metallic nanoparticles, graphite, carbon nanotubes, graphene, conductive polymer or a conductive ink.

9. The electrochemical sensing device according to claim 1, which is formed by the following layers:
a bottom enclosing layer;
the conductive supports and measuring terminals;
a first intermediate enclosing layer provided with through holes for housing the membranes, and cuts for accessing the measuring terminals;
a second intermediate enclosing layer comprising a through hole that defines two housings for the first volume and the second volume and a channel, which connects the housings and that houses the salt bridge and cuts for accessing the measuring terminals; and
a top enclosing layer comprising a through hole for depositing the biological fluid sample and cuts for accessing the measuring terminals.

10. The electrochemical sensing device for measuring the content of ions in a biological fluid sample comprising:
a first half cell provided with a first ion-selective electrode made of a first ion-selective membrane and a first conductive support;
a second half cell provided with a second ion-selective electrode made of a second ion-selective membrane a second conductive support;
a salt bridge connecting first ion-selective membrane and the second ion-selective membrane;
means for bringing a biological fluid sample in contact with the salt bridge in the vicinity of the second ion-selective membrane;
wherein the first and second membranes are selective to the same ions, and which comprises a first calibration volume with a known concentration of the ions to which the membranes are selective, the calibration volume being placed in contact with the salt bridge in the vicinity of the first ion-selective membrane, the salt bridge being filled with a known concentration of the ions to which the membranes are selective, and which comprises a diffusion limiter between the calibration volume and the salt bridge, such that a voltage can be measured between the first electrode and the second electrode that allows calibrating the electrochemical sensing device when the diffusion limiter is removed, and then measuring the ion-content of the biological fluid sample.

11. The electrochemical sensing device according to claim 10, which comprises a second calibration volume with a known concentration of the ions to which the membranes are selective, the second calibration volume being placed in contact with the salt bridge in the vicinity of the second ion-selective membrane.

12. The electrochemical sensing device according to claim 10 configured as a strip.

13. A method for measuring the content of ions in a biological fluid sample by using the electrochemical sensing device according to claim 10, which after removing the diffusion limiter(s) comprises the steps of:
a) measuring the voltage (V_{CAL}) between the first half cell and the second half cell for calibrating the device in order to determine the calibration equation;
b) placing a biological fluid sample in contact with the second volume;
c) measuring the voltage (V_{SAMP}) between first half cell and the second half cell after a sufficient time has lapsed for the ions of the fluid sample to diffuse into the second ion-selective membrane such that a stable measure can be taken; and
d) determining the ion concentration in the biological fluid sample.

14. The method according to claim 13, wherein the step of removing the diffusion limiter(s) is carried out while coupling the electrochemical sensing device to a reading terminal.

15. An electrochemical sensing device for measuring the content of ions in biological fluid samples comprising:
a first half cell provided with a first ion-selective electrode made of a first ion-selective membrane and a first conductive support, and a first volume in contact with the first ion-selective membrane;
a second half cell provided with a second ion-selective electrode made of a second ion-selective membrane and a second conductive support, and a second volume in contact with the second ion-selective membrane;
a salt bridge connecting the first volume and the second volume; and
means for bringing a biological fluid sample in contact with the second volume,
wherein the salt bridge comprises a diffusion limiter, which allows opening the salt bridge when it is removed, and wherein the first volume, the second volume and the salt bridge are a hydrogel.

16. The electrochemical sensing device according to claim 1 configured as a strip.

17. A method for measuring the content of ions in a biological fluid sample by using the electrochemical sensing device according to claim 1, which after removing the diffusion limiter(s) comprises the steps of:
a) measuring the voltage (V_{CAL}) between the first half cell and the second half cell for calibrating the device in order to determine the calibration equation;
b) placing a biological fluid sample in contact with the second volume;
c) measuring the voltage (V_{SAMP}) between first half cell and the second half cell after a sufficient time has lapsed for the ions of the fluid sample to diffuse into the second ion-selective membrane such that a stable measure can be taken; and
d) determining the ion concentration in the biological fluid sample.

18. The method according to claim 17, wherein the step of removing the diffusion limiter(s) is carried out while coupling the electrochemical sensing device to a reading terminal.
